(19) United States
(12) Patent Application Publication
(10) Pub. No.: US 2004/0115486 A1
(43) Pub. Date: Jun. 17, 2004

(54) Fuel cell

(76) Inventors: Naohiro Takeshita, Toyota-shi (JP); Tsuyoshi Takahashi, Nishikamo-gun (JP); Toshiyuki Suzuki, Toyota-shi (JP); Chisato Kato, Aichi-gun (JP); Hiroya Nakaji, Toyota-shi (JP); Yasuyuki Asai, Toyota-shi (JP); Hironori Noto, Susono-shi (JP)

Correspondence Address: KENYON & KENYON, 1500 K STREET, N.W., SUITE 700, WASHINGTON, DC, 20005, US

(21) Appl. No.: 10/720,244

(22) Filed: Nov. 25, 2003

(30) Foreign Application Priority Data
Nov. 28, 2002 (JP) 2002-345955

(51) Int. Cl. H01M 8/24; H01M 16/00

(52) U.S. Cl. 429/9; 429/12; 429/38

(57) ABSTRACT

In a fuel cell according to an aspect of the invention, a fuel cell stack is formed by stacking several cells in which pressure loss is small as compared with normal cells, in the vicinity of an end portion of the stack, which is far from a fuel gas supply port and an oxidizing gas supply port.

### INCORPORATION BY REFERENCE

The present application claims foreign priority to Japanese Patent Application No. 2002-345955 filed on Nov. 28, 2002, the disclosure of which, including its specification, drawings and abstract, is incorporated herein by reference in its entirety.

### BACKGROUND OF THE INVENTION

1. Field of the Invention

The present invention relates to a fuel cell.

2. Description of the Related Art

In Japanese Laid-Open Publication No. 2001-236975, a fuel cell is proposed including a bypass plate for allowing gas supplied to an end portion of a fuel cell stack to flow from a supply passage directly to a discharge passage. In the above fuel cell, the gas supplied to one end portion of the fuel cell stack passes through the supply passage formed in a stacking direction so as to be supplied to each cell. Thereafter, the gas passes through the discharge passage formed in the stacking direction so as to be discharged from the end portion to which the gas has been supplied. The bypass plate is disposed in the other end portion of the stack such that any water accumulated in the vicinity of the other end portion is discharged for the cell in the portion to function appropriately.

Since the bypass plate needs to be disposed in the end portion of the fuel cell stack, the size of the fuel cell stack is large, and cannot be reduced. Also, since the gas flowing to the bypass plate does not contribute to electric power generation, the electric power generation efficiency is decreased. Further, in the fuel cell including the fuel cell stack formed by stacking cells, it is difficult to operate all the cells under the same operating condition. Therefore, consideration needs to be given to a slight difference among the operating conditions.

### SUMMARY OF THE INVENTION

It is an object of the invention to improve electric power generation performance of a fuel cell stack. It is another object of the invention to reduce a size of the fuel cell stack.

In order to achieve at least part of the aforementioned objects, a fuel cell according to the invention is configured as follows.

A fuel cell according to an aspect of the invention includes a fuel cell stack formed by stacking plural cells of varying types, each of the types having a different characteristic.

In the embodiments of fuel cell according to the invention, since the fuel cell stack is formed by stacking plural cells of varying types, each of the types having a different characteristic, the fuel cell stack can be formed by disposing the cells having different characteristics appropriate to different operating conditions at different positions in the stack. As a result, electric power generation performance of the fuel cell stack can be improved. Also, since the bypass plate is not employed unlike in the aforementioned conventional fuel cell, the size of the fuel cell stack can be reduced, and a gas flow which does not contribute to electric power generation can be suppressed. The fuel cell according to the invention may be a proton-exchange membrane fuel cell formed by stacking cells, each cell including an electrolyte membrane formed from a solid polymer material.

In the fuel cell according to the invention, the fuel cell stack may be composed of varying types of cell blocks, each of the blocks being formed by stacking plural cells of the same type. Thus, the varying types of cell blocks, each type of which is formed by stacking the cells having a different characteristic, can be disposed at different portions in the fuel cell stack. By “type”, what is meant in the context of the present invention is the performance (or “characteristic”) of the cell, for example, in terms of gas pressure losses and/or water draining.

In the fuel cell according to the invention, the fuel cell stack may be formed using, as one of the cells of varying types, a small pressure loss type cell in which loss of pressure of gas flowing therethrough is small compared with a normal cell. Thus, the electric power generation performance of the fuel cell stack can be improved by disposing the small pressure loss type cell in a portion in which the gas pressure loss is likely to occur in the fuel cell stack.

In the fuel cell according to the invention in which the small pressure loss type cell is used, the fuel cell stack may be formed by stacking the cells such that the small pressure loss type cell is disposed in the vicinity of an end portion of the fuel cell stack. Further, the fuel cell stack may comprise a supply port through which gas is supplied to the fuel cell stack, and which is provided in one end portion of the fuel cell stack, and the fuel cell stack may be formed by stacking the cells such that the small pressure loss type cell is disposed in a vicinity of the other end portion of the fuel cell stack. Thus, the gas can be appropriately supplied in the vicinity of the end portion of the stack. In addition, it is possible to improve performance in draining water that may be accumulated in the vicinity of the end portion. As a result, the electric power generation performance of the fuel cell stack can be improved.

Also, in the fuel cell according to the invention in which the small pressure loss type cell is used, the fuel cell stack may be formed by stacking the cells such that the small pressure loss type cell is disposed in a portion in which a shortage of gas supply is likely to occur. Thus, it is possible to improve performance in supplying the gas to the cell in the portion in which the shortage of gas supply is likely to occur in the fuel cell stack. Therefore, the electric power generation performance of the entire fuel cell stack can be improved.

Further, in the fuel cell according to the invention in which the small pressure loss type cell is used, the small pressure loss type cell may be formed such that a space through which gas passes in a gas passage is large as compared with the normal cell. Alternatively, the small pressure loss type cell may be formed such that the gas passage is short as compared with the normal cell.

In the fuel cell according to the invention, the fuel cell stack may be formed using, as one of the cells of varying types, a water proof type cell whose performance is good when flooding occurs as compared with performance of a normal cell when flooding occurs. In this case, the fuel cell stack may be formed by stacking the cells such that the water proof type cell is disposed in a portion in which flooding is likely to occur. Thus, it is possible to improve the electric power generation performance in the portion in which flooding is likely to occur in the fuel cell stack. Therefore, the electric power generation performance of the entire fuel cell stack can be improved. And, the water proof type cell includes a high drainage performance type cell having high drainage performance as compared with a normal cell.

A fuel cell according to another aspect of the invention includes plural first cells and at least one second sell which has a characteristic different from that of the first cell.

### BRIEF DESCRIPTION OF THE DRAWINGS

The foregoing and further objects, features and advantages of the invention will become apparent from the following description of preferred embodiments with reference to the accompanying drawings, wherein like numerals are used to represent like elements and wherein:

FIG. 1 is a view of an outline of a fuel cell 10 according to an embodiment of the present invention;

FIG. 2 is a schematic, cross-sectional view of each of cells 20, 20b of FIG. 1;

FIG. 3A and FIG. 3B are exploded perspective views, each showing an outline of each of the cells 20, 20b of FIG. 1;

FIG. 4 is a diagram showing an example of a relationship between a position of a cell and an amount of gas supplied to the cell when fuel gas and oxidizing gas are supplied to a fuel cell according to an embodiment of the present invention and a fuel cell according to a comparative example; and

FIG. 5 is a view of an outline of a fuel cell including two fuel cell stacks according to a modified embodiment of the present invention.

### DETAILED DESCRIPTION OF THE PREFERRED EMBODIMENTS

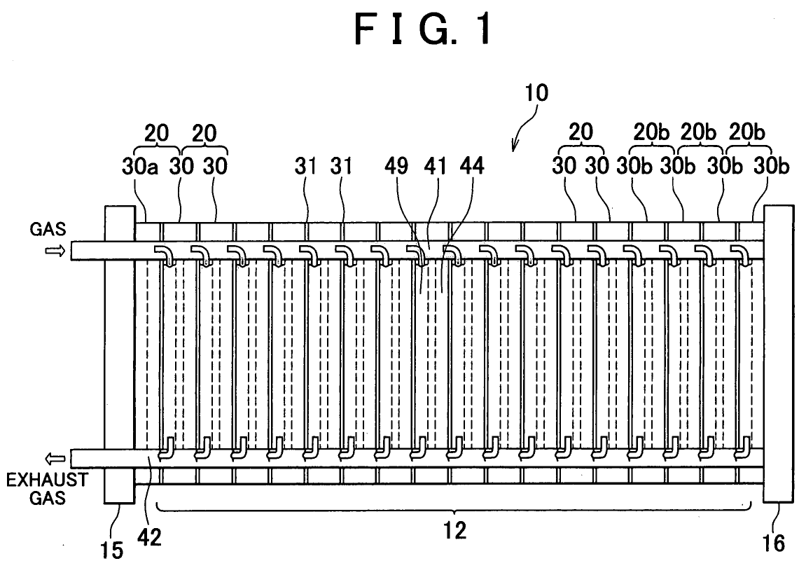

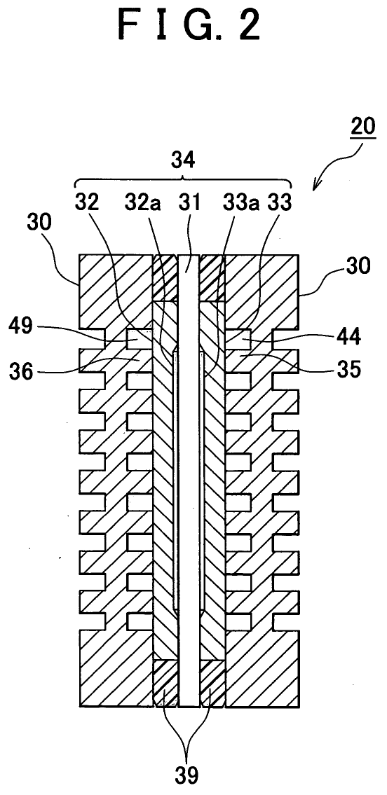

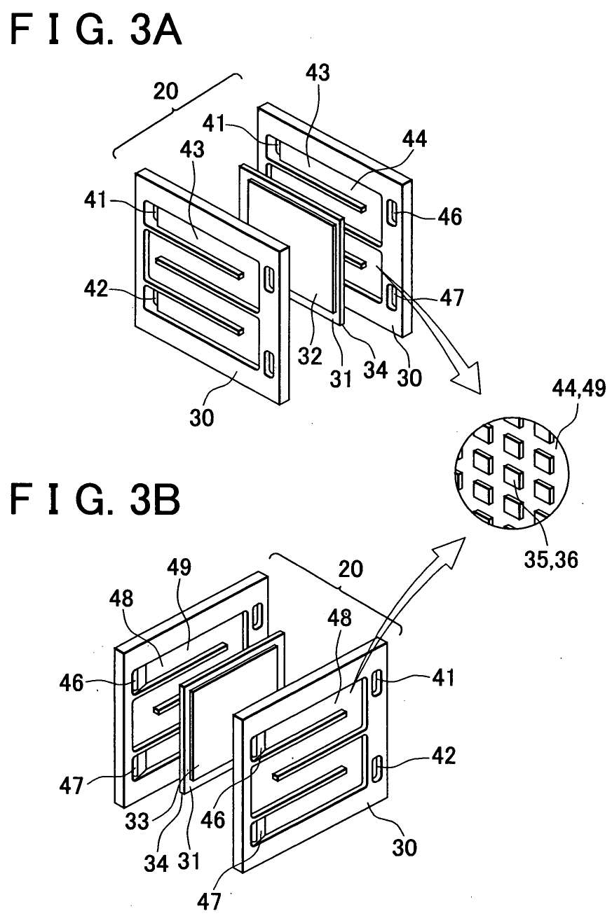

Hereinafter, an embodiment of the present invention will be described with reference to the accompanying drawings. FIG. 1 is a view of an outline of a fuel cell 10 according to an embodiment of the present invention. FIG. 2 is a schematic view of each of cells 20, 20b. FIG. 3A and FIG. 3B are exploded perspective views, each showing an outline of the configuration of each of the cells 20, 20b. As shown in FIG. 1, in the fuel cell 10 according to an embodiment of the present invention, a fuel cell stack 12 is formed by stacking plural cells 20 and stacking several cells 20b in the vicinity of a right end portion in the FIG. 1. The cell 20 is a basic unit which functions as a proton-exchange membrane fuel cell, for example. The cell 20b is designed such that gas pressure loss in the cell 20b is smaller than that in the cell 20. A current collecting plate and an insulating plate (not shown) are disposed at both ends of the fuel cell stack 12. Further, end plates 15, 16 are disposed at both of those ends. As shown by arrows indicating a gas flow in FIG. 1, in the fuel cell 10 according to the shown embodiment, fuel gas containing hydrogen and oxidizing gas containing oxygen flow in each of the cells 20, 20b so as to be supplied to each of the cells 20, 20b, and exhaust gas is discharged from each of the cells 20, 20b. Accordingly, the cell 20b in which the pressure loss is small is disposed in the vicinity of the end portion which is far from a gas supply port.

As shown in FIG. 2, each of the cells 20, 20b includes an electrolyte membrane 31, an anode 32, a cathode 33, and separators 30. The electrolyte membrane 31 is formed by coating a proton conductive ion-exchange membrane (for example, a NAFION membrane manufactured by Du Pont Ltd.) with catalytic electrodes 32a, 33a. The ion-exchange membrane is formed from solid polymer material (for example, fluorocarbon resin). Each of the catalytic electrodes 32a, 33a is made of platinum or alloy of platinum and other metals. Each of the anode 32 and the cathode 33 is formed from carbon cloth, which is woven using thread made of carbon fiber. The anode 32 and the cathode 33 are disposed on both sides of the electrolyte membrane 31, and serve as gaseous diffusion electrodes. Each of the separators 30 is formed from a conductive member which is gas impermeable (for example, formed carbon which is made gas impermeable by compressing carbon). The separators 30 serve as partition walls between the cells 20, 20b. The separators 30 also form a fuel gas passage 49 for supplying fuel gas containing hydrogen to the anode 32 and cathode 33, and an oxidizing gas passage 44 for supplying oxidizing gas containing oxygen to the anode 32 and the cathode 33. The anode 32 and the electrolyte membrane 31 are integrated by thermal press fitting, and the cathode 33 and the electrolyte membrane 31 are integrated by thermal press fitting. Thus, the electrolyte membrane 31, the anode 32, and the cathode 33 constitute a membrane electrode assembly (hereinafter, referred to as MEA) 34.

As shown in FIG. 3A and FIG. 3B, in each of the separators 30, 30b, two opening portions, which constitute an oxidizing gas supply port 41 and an oxidizing gas discharge port 42, are provided along one side of the separator. Two opening portions, which constitute a fuel gas supply port 46 and a fuel gas discharge port 47, are provided along a side opposite to the aforementioned side. A concave groove 43 is provided on one surface of each of the separators 30. The concave groove 43 extends in a curved path from the oxidizing gas supply port 41 to the oxidizing. gas discharge port 42. A concave groove 48 is provided on the other surface of each of the separators 30. The concave groove 48 extends in a curved path from the fuel gas supply port 46 to the fuel gas discharge port 47. The concave groove 43 forms the oxidizing gas passage 44 when the separator 30 closely contacts the cathode 33 of the MEA 34. The concave groove 48 forms the fuel gas passage 49 when the separator 30 closely contacts the anode 32 of the MEA 34. Plural rectangular ribs 35, 36 are formed so as to be dispersed throughout the concave groove 43 and the concave groove 48, which respectively form the oxidizing gas passage 44 and the fuel gas passage 49. A top portion of each of the ribs 35, 36 can apply a surface pressure to the anode 32 and the cathode 33. As shown in FIG. 2, a sealing member 39 is disposed between both separators 30. The sealing member 39 contacts both sides of the electrolyte membrane 31 so as to prevent the fuel gas and the oxidizing gas from leaking, and to prevent those gases from being mixed between both separators 30.

In the case of the separator 30b of the cell 20b in which the pressure loss is small, the ribs 35, 36 in the concave groove 43 and the concave groove 48 are formed to be slightly smaller than those in the separator 30 of the normal cell 20. In other words, a cross sectional area of each of the ribs 35, 36 is formed to be smaller such that a pitch between the ribs 35, 36 is larger. Since the ribs 35, 36 in the cell 20b are formed in this manner, substantial spaces of gas paths through which the gases actually pass are increased in the oxidizing gas passage 44 and the fuel gas passage 49, whereby the pressure loss becomes smaller than that in the cell 20.

In a separator 30a disposed at a left end portion in FIG. 1, only the concave groove on one surface of the separator 30 constituting the normal cell 20 is formed. In a separator 30c disposed at a right end portion in FIG. 1, only the concave groove on one surface of the separator 30b constituting the cell 20b in which the pressure loss is small is formed. Thus, the separator 30a in the left end portion and the separator 30 constitute the normal cell 20. In addition, the separator 30c in the right end portion and the separator 30 constitute the cell 20b in which the pressure loss is small.

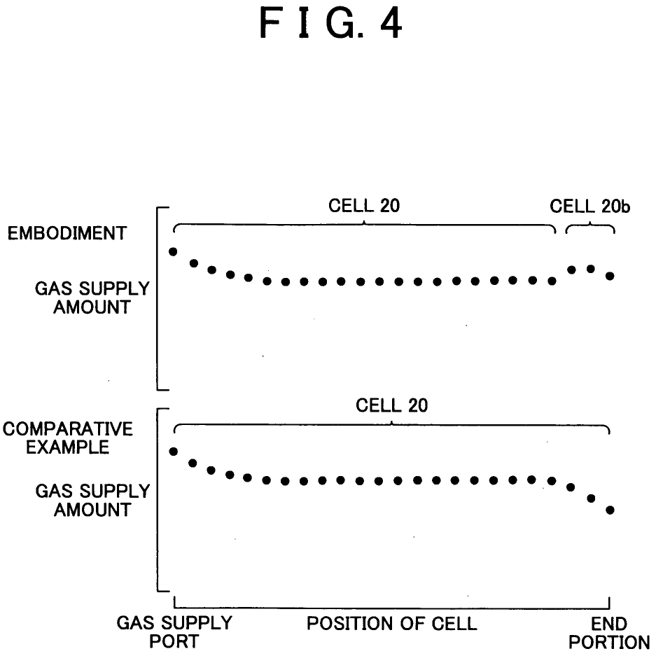

Subsequently, electric power generation of the fuel cell 10 thus configured according to the above embodiment of the present invention will be described. Particularly, supply of the fuel gas and the oxidizing gas to each of the cells 20, 20b will be described. FIG. 4 is a diagram showing an example of a relationship between a position of a cell and an amount of gas supplied to the cell when fuel gas and oxidizing gas are supplied to the fuel cell 10 according to one embodiment of the present invention and a fuel cell according to a comparative example. The fuel cell according to the comparative example is formed by stacking only the normal cells 20 without using the cell 20b in which the pressure loss is small. As shown in FIG. 4, in the fuel cell 10 according to the shown embodiment of the present invention, the amount of gases supplied to each of the cells 20b disposed in the vicinity of the end portion which is far from the fuel gas supply port 46 and the oxidizing gas supply port 41 is large, as compared with the fuel cell formed by stacking only the normal cells 20 according to the comparative example. In general, an operating temperature is likely to become low in the end portion of the fuel cell stack due to the influence of outside air and the like. Therefore, when the supply amount of the fuel gas and the oxidizing gas is small, water produced due to electric power generation cannot be discharged efficiently, and the water is likely to be accumulated. When the water is accumulated, the gas path is blocked by the accumulated water, which causes a shortage of supply of the fuel gas and the oxidizing gas, and decreases voltage. In the fuel cell 10 according to the shown embodiment of the present invention, sufficient gases can be supplied also to the cells 20b disposed in the vicinity of the end portion of the fuel cell stack 12, which is far from the fuel gas supply port 46 and the oxidizing gas supply port 41. Thus, a decrease in the voltage due to the shortage of gas supply hardly occurs.

According to the fuel cell 10 in the shown embodiment of the present invention, the cells 20b in which the pressure loss is small as compared with the normal cells 20 are disposed in the vicinity of the end portion which is far from the fuel gas supply port 46 and the oxidizing gas supply port 41. Therefore, it is possible to supply the gases such that an amount of the gases supplied to each of the cells 20b in the vicinity of the end portion is equal to or larger than an amount of the gases supplied to each of the other cells 20. As a result, it is possible to prevent a decrease in performance in draining water that may be produced in the vicinity of the end portion, blockage of the gas path due to the decrease in the drainage performance, or the like. Accordingly, performance of the entire fuel cell stack 12 can be improved. Also, according to the fuel cell 10 in the shown embodiment of the present invention, the bypass plate, which is disposed in the end portion of the fuel cell stack so as to allow the fuel gas and the oxidizing gas to flow from the supply passage directly to the discharge passage, is not employed, unlike in the fuel cell that has been described as the conventional example. Thus, the fuel cell stack 12 can be made smaller than the fuel cell stack in which the bypass plate is employed.

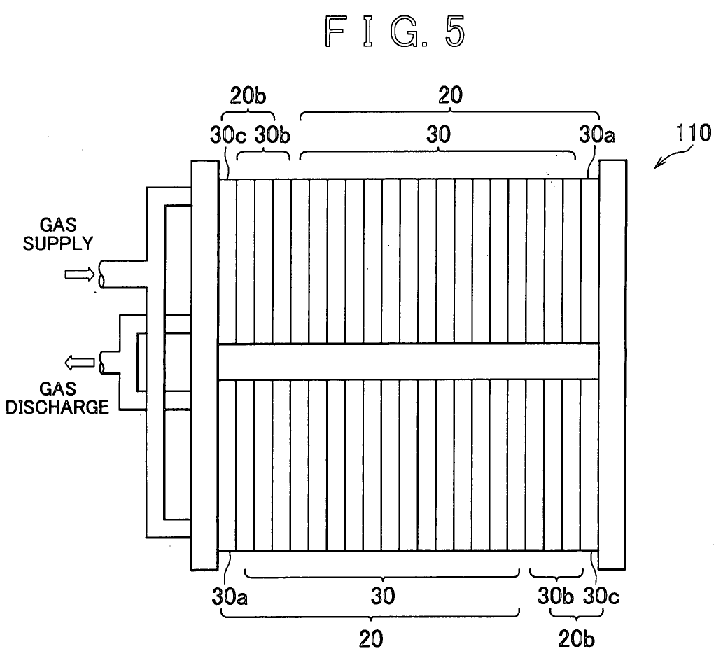

In the fuel cell 10 according to the shown embodiment of the present invention, the fuel cell stack 12 is formed by stacking the cells 20b in which the pressure loss is small as compared with the normal cells 20, in the vicinity of the end portion which is far from the fuel gas supply port 46 and the oxidizing gas supply port 41. However, the fuel cell stack may be formed by stacking at least one cell 20b in which the pressure loss is small in the vicinity of the end portion in which the fuel gas supply port 46 and the oxidizing supply port are formed. Thus, sufficient amount of the gases can be supplied to the vicinity of the fuel gas supply port 46 and the oxidizing gas supply port 41 even if the operating temperature is slightly decreased due to influence of outside air in the portion. Therefore, influence of a decrease in the temperature can be suppressed. For example, as in a fuel cell 110 including two fuel cell stacks according to a modified embodiment of the present invention shown in FIG. 5, one stack may be formed by stacking at least one cell 20b in which the pressure loss is small in the vicinity of the end portion which is far from the fuel gas supply port 46 and the oxidizing gas supply port 41, and the other stack may be formed by stacking at least one cell 20b in which the pressure loss is small in the vicinity of the end portion in which the fuel gas supply port 46 and the oxidizing gas supply port 41 are formed. The fuel cell may include any number of fuel cell stacks.

In the fuel cell 10 according to the shown embodiment of the present invention, the fuel cell stack 12 is formed by stacking the cells 20b in which the pressure loss is small as compared with the normal cells 20, in the vicinity of the end portion which is far from the fuel gas supply port 46 and the oxidizing gas supply port 41. However, the portion in which the cell 20b is stacked is not limited to the vicinity of the end portion. At least one cell 20b in which the pressure loss is small may be stacked in a portion in which the shortage of supply of the fuel gas and the oxidizing gas is likely to occur. Thus, it is possible to improve performance in supplying the gases to the cell in the portion in which the shortage of gas supply is likely to occur. Therefore, electric power generation performance of the entire fuel cell stack can be improved. The portion in which the shortage of gas supply is likely to occur in the fuel cell stack varies depending on shapes of the oxidizing gas supply port 41, the oxidizing gas discharge port 42, the fuel gas supply port 46, the fuel gas discharge port 47, and the like, and a method of supplying the fuel gas and the oxidizing gas to the end plate 15. However, the portion in which the shortage of gas supply is likely to occur can be determined in each fuel cell stack, through experiments or the like.

In the fuel cell 10 according to the shown embodiment of the present invention, the cell 20b in which the pressure loss is small is configured using the separator 30b in which the ribs 35, 36 in the concave groove 43 and the concave groove 48 are formed to be slightly smaller than those in the separator 30 of the cell 20. However, the cell 20b may have other configurations, as long as the pressure loss in the cell 20b becomes smaller than that in the cell 20. For example, the cell 20b may be configured using a separator in which shapes of the ribs 35, 36 are the same as those in the separator 30, but at least one of the concave groove 43 and the concave groove 48 is slightly deeper than that in the separator 30. Alternatively, the cell 20b may be configured using a separator in which at least one of the concave groove 43 from the oxidizing gas supply port 41 to the oxidizing gas discharge port 42 and the concave groove 48 from the fuel gas supply port 46 to the fuel gas discharge port 47 is shorter than that in the separator 30.

In the fuel cell 10 according to the shown embodiment of the present invention, the fuel cell stack 12 is formed by stacking the normal cells 20 and the cells 20b in which the pressure loss is small as compared with the cells 20. However, the fuel cell stack may be formed by stacking at least one cell having high drainage performance as compared with the cell 20, in the end portion of the stack or in a portion in which water is likely to be accumulated. Thus, it is possible to suppress influence of flooding that may occur in a part of the fuel cell stack. Therefore, performance of the entire fuel cell stack can be improved. Examples of the cell having high drainage performance include a cell in which surfaces of the concave groove 43 and the concave groove 48 of the separator 30 have been subjected to water-repellent treatment or hydrophilic treatment. The portion in which water is likely to be accumulated in the fuel cell stack can be determined in advance in each fuel cell stack through experiments or the like. Thus, the cells of varying types having different characteristics are prepared, and the fuel cell stack is configured by using the cells having the different characteristics appropriate to different portions of the stack, whereby the performance of the entire fuel cell stack can be improved.

In the case of the fuel cell 10 according to the shown embodiment of the present invention, the fuel cell stack formed by stacking the cells having different characteristics according to the invention is applied to the proton-exchange membrane fuel cell. However, the invention is not limited to the proton-exchange membrane fuel cell, and may be applied to any types of fuel cells.

Although the embodiments of the invention have been described, it is to be understood that the invention is not limited to the embodiments, and the invention can be realized in various embodiments without departing from the true spirit of the invention.

What is claimed is:

1. A fuel cell comprising:
a fuel cell stack formed by stacking plural cells of varying types, each of the types having a different characteristic.

2. The fuel cell according to claim 1, wherein the fuel cell stack is composed of varying types of cell blocks, each of the blocks being formed by stacking plural cells of the same type.

3. The fuel cell according to claim 1, wherein the fuel cell stack is formed using, as one of the cells of varying types, a small pressure loss type cell in which loss of pressure of gas flowing therethrough is small compared with a normal cell.

4. The fuel cell according to claim 3, wherein the fuel cell stack is formed by stacking the cells such that the small pressure loss type cell is disposed in a vicinity of an end portion of the fuel cell stack.

5. The fuel cell according to claim 3, wherein the fuel cell further comprises a supply port through which gas is supplied to the fuel cell stack, and which is provided in one end portion of the fuel cell stack, and the fuel cell stack is formed by stacking the cells such that the small pressure loss type cell is disposed in a vicinity of the other end portion of the fuel cell stack.

6. The fuel cell according to claim 5, wherein the fuel cell further comprises a discharge port through which gas is discharged from the fuel cell stack, and which is provided in the same end portion of the fuel cell stack as the supply port.

7. The fuel cell according to claim 3, wherein the fuel cell stack is formed by stacking the cells such that the small pressure loss type cell is disposed in a portion in which a shortage of gas supply is likely to occur.

8. The fuel cell according to claim 3, wherein the small pressure loss type cell is formed such that a cross section of a gas path through which gas actually passes is large as compared with the normal cell.

9. The fuel cell according to claim 3, wherein the small pressure loss type cell is formed such that a gas path through which gas actually passes is short as compared with the normal cell.

10. The fuel cell according to claim 1, wherein the fuel cell stack is formed using, as one of the cells of varying types, a water proof type cell whose performance is good when flooding occurs as compared with performance of a normal cell when flooding occurs.

11. The fuel cell according to claim 10, wherein the fuel cell stack is formed by stacking the cells such that the water proof type cell is disposed in a portion in which flooding is likely to occur.

12. The fuel cell according to claim 11, wherein each of the cells includes an electrolyte membrane formed from solid polymer material.

13. The fuel cell according to claim 10, wherein the water proof type cell includes a high drainage performance type cell having high drainage performance as compared with a normal cell.

14. A fuel cell comprising:
plural first cells that are stacked; and
at least one second cell which has a characteristic different from that of the first cell.
